(19) United States
(12) Patent Application Publication
(10) Pub. No.: US 2025/0371922 A1
(43) Pub. Date: Dec. 4, 2025

(54) DEVICE AND METHOD FOR TESTING FLAT SAMPLES

(71) Applicant: GIESECKE+DEVRIENT CURRENCY TECHNOLOGY GMBH, Munchen (DE)

(72) Inventors: Wolfgang DECKENBACH, Schechen (DE); Julia DANHOF, Egling a.d. Paar (DE); Martin CLARA, Munchen (DE); Henning GEISELER, Munchen (DE)

(21) Appl. No.: 18/874,228

(22) PCT Filed: Jun. 23, 2023
(86) PCT No.: PCT/DE2023/100475

§ 371 Date: Dec. 12, 2024

(30) Foreign Application Priority Data
Jun. 29, 2022 (DE) 10 2022 002 352.0

(51) Int. Cl. G07D 7/121

(52) U.S. Cl. CPC G07D 7/121; G07D 2207/00

(57) ABSTRACT

A device and a method for testing flat samples, include an optical sensor module which for optically testing the flat sample captures a measurement signal of the flat sample when the flat sample is located in the target measurement plane or at least approximately in the target measurement plane. A window is arranged between the sensor module and the flat sample at a window distance from the target measurement plane. The sensor module is arranged at a module distance from the target measurement plane. The module distance is selected to be sufficiently small for a signal variation of the measurement signal of the flat sample as a function of the measurement distance deviation in the region of the target measurement plane to be reduced by the retroreflection effect of the window compared to a signal variation occurring without the retroreflection effect.

The invention relates to a device and a method for testing flat samples, in particular value documents or semi-finished products used for producing value documents, e.g. for testing the authenticity of value documents or for quality testing the value documents or semi-finished products in the production of value documents.

In order to secure value documents, it is known to incorporate machine-testable security features into the value documents or attach such security features to them. For this purpose, certain luminescent substances or remission inks can be used, for example.

When producing such security documents, a quality test is normally provided, e.g. to ensure that the finished value documents contain the security feature in a predetermined quantity and/or with predetermined properties. For this purpose, provision may be made to test the value documents, or semi-finished products used to produce the value documents, such as paper sheets or webs, at least on a random-sampled basis in a production device or in a separate quality control device and only release them as fit for circulation if they meet specified criteria, whereas all other value documents or semi-finished products are discarded as scrap and, if necessary, destroyed.

In addition, value documents that are already in circulation are usually subjected from time to time to an optical authenticity check with the aid of value document processing devices in order to be able to detect and discard any falsified or suspected counterfeit value documents.

Both during optical quality testing and optical authenticity testing, the value document can be irradiated with light and the optical radiation emanating from the value document, in particular remission or luminescent light, can be detected by means of a sensor module and analyzed in order to test the security feature.

In production devices for value documents or in quality control devices or in value document processing devices, the optical testing of the security features is usually carried out by means of a static optical sensor module, which the value documents or semi-finished products are transported past and which is arranged in the respective device at a distance from the value document or semi-finished product to be tested. When transporting the value documents or semi-finished products past the sensor module, the value documents or semi-finished products may sometimes lift slightly or flutter out of the desired transport plane, so that fluctuations in the distance relative to the optical sensor module can occur. If the measurement signal of the optical sensor module depends on the distance between the tested value documents or semi-finished products, the lifting or fluttering can distort the measurement signal. It has therefore been necessary before now to allow a deviation from the expected measurement signal or a certain acceptance range in the quality test or authenticity test. A wide acceptance range leads to a less stringent quality check or authenticity check and therefore carries the risk that actually unacceptable quality deviations or some counterfeit value documents could be overlooked.

It is known to reduce the fluttering or lifting of the value documents from their transport plane by providing the transport path of the value documents or semi-finished products with mechanical boundaries, e.g. guide elements. However, such mechanical boundaries cannot be arranged arbitrarily close to the transport path in the abovementioned devices, as this can lead to a transport malfunction or damage to the value documents or semi-finished products, in particular if these are transported past the sensor module at high speed.

It is an object of the invention to provide a method and a device for testing flat samples, such as value documents or semi-finished products used for producing the value documents, with which a more stable measurement signal can be achieved.

This object is achieved by a method and a device for testing the flat samples according to the independent claims.

The flat samples to be tested are, in particular, value documents or semi-finished products used for producing the value documents.

The device comprises an optical sensor module and is designed for optical testing, e.g. testing the authenticity or quality, of the respective flat sample by means of the optical sensor module, wherein the device provides or defines a target measurement plane for the flat sample, in which the flat sample can be inserted for optical testing. Preferably, for optical testing the flat sample is introduced into the target measurement plane—viewed along the sample normal—in such a way that a detection region of the planar sample (e.g. lying on the sample surface) detected while capturing the measurement signal lies (at least approximately) in the target measurement plane. In particular, the optical sensor module is arranged in the device or is built into it. The target measurement plane is arranged outside the sensor module and is located, for example, within the device or at least adjacent to it, in such a way that the sensor module of the device can capture measurement signals of the flat sample.

The optical sensor module for optically testing the flat sample is designed to capture a measurement signal of the flat sample corresponding to the intensity of an optical radiation, in particular remission or luminescence light, of the flat sample when the sample is located in the target measurement plane or at least approximately in the target measurement plane, in particular while the flat sample (e.g. in the device) is transported past the sensor module along a transport path located in or at least approximately in the target measurement plane, e.g. by means of a transport unit of the device. The optical sensor module is designed to carry out the optical test, e.g. authenticity or quality test, of the flat sample on the basis of the measurement signal and, optionally, further measurement signals of the flat sample captured in this manner.

The sensor module is arranged at a module distance away from the target measurement plane or from the transport path. Between the sensor module and the flat sample, a window is arranged, through which both illumination/excitation light (from a light source of the sensor module or from a light source of the device) irradiated onto the flat sample as well as the optical radiation reaching the sensor module from the flat sample, in particular remission or luminescence light which is emitted from the flat sample as a result of the illumination/excitation light, is transmitted.

The window is arranged at a window distance away from the target measurement plane and the window distance is selected sufficiently small that the measurement signal of the flat sample in the target measurement plane is increased by a retroreflection effect of the window, preferably by at least 10%, in comparison to a corresponding measurement signal of the flat sample located in the target measurement plane occurring or able to be captured without the retroreflection effect, or in comparison to a corresponding device in which the window—e.g. due to its greater distance from the flat sample—does not cause a retroreflection effect. The retroreflection effect is based on the optical reflection law and is explained in detail below.

Preferably, the window arranged between the sensor module and the flat sample is arranged at a window distance from the target measurement plane of at least 0.3 mm, preferably of at least 0.5 mm, and particularly preferably of a maximum of 3 mm, e.g. of a maximum of 2 mm. The window is designed as a transparent solid body, e.g. as a glass plate. Through the same window, both the illumination/excitation light irradiated by the sensor module onto the flat sample and the optical radiation reaching the sensor module from the flat sample, in particular remission or luminescence light reaching the sensor module from the flat sample, is transmitted.

The module distance of the sensor module from the target measurement plane is selected to be sufficiently small that a signal variation of the measurement signal of the flat sample as a function of the measurement distance deviation in the region of the target measurement plane is reduced by the retroreflection effect of the window in comparison to a signal variation of the measurement signal of the flat sample occurring without the retroreflection effect as a function of the measurement distance deviation in the region of the target measurement plane, or in comparison to a corresponding device in which the window—e.g. due to its greater distance from the flat sample—causes no or only a negligibly small retroreflection effect.

By selectively reducing the module distance of the sensor module from the target measurement plane, using the retroreflection effect of the window, the signal variation of the measurement signal as a function of the measurement distance deviation in the region of the target measurement plane is significantly reduced.

This results in a more stable measurement signal that depends only slightly on the exact distance of the flat sample from the sensor module. Nevertheless, a sufficiently high measurement signal is achieved to enable measurement of even weak measurement signals with a good signal-to-noise ratio.

Preferably, the module distance of the sensor module from the target measurement plane is at least 2 mm.

To compensate for manufacturing tolerances, the module distance can be set individually for each sensor module (e.g. for the individual sensor modules of a sensor series), for example to minimize the signal variation of the measurement signal as a function of the measurement distance deviation (on a sensor-specific basis). For example, each device has an individual module distance of the respective sensor module, which differs from other devices of the same series. In particular, the device may be configured to adjust the module distance of the sensor module, for example, by fixing the sensor module to a displacement table or by means of slotted holes in the device.

The optical sensor module has at least one detector device for capturing the measurement signal, which is configured to detect the optical radiation emitted from the flat sample, in particular remission or luminescence light, and optionally at least one light source, which is configured to irradiate the illumination or excitation light onto the flat sample. Preferably, the detector device is arranged such that its optical axis runs perpendicular to the target measurement plane or perpendicular to the sample normal of the flat sample.

The sensor module, in particular the detector device(s) and/or the light source(s), and the window are arranged and designed, for example, in such a way that the following contribute to the retroreflection effect of the window,
that a portion of the illumination/excitation light is reflected or scattered at the flat sample toward the window and then, in particular at a large angle of incidence (approx. >50° to the sample normal), partially reflected back from the window to the flat sample due to the reflection law and causes the flat sample to emit additional optical radiation, in particular additional remission or luminescence light, which is reflected or scattered in the direction of the window in such a way that it can be detected by the sensor module or its detector device(s) through the window and contributes to the measurement signal, and/or
that the optical radiation emitted by the flat sample, in particular remission or luminescence light (e.g. which is emitted isotropically from the flat sample in all directions) caused by the illumination/excitation light, strikes the window and, in particular at a large angle of incidence (approx. >50° to the sample normal), a component of the optical radiation, in particular of the remission or luminescence light, is reflected back to the flat sample again at the window due to the reflection law and then reflected or scattered at the flat sample again in the direction of the window in such a way that it can be detected by the sensor module or its detector device(s) through the window and contributes to the measurement signal.

Preferably, the sensor module is designed to receive one or more local measurement signals of the flat sample at one or more discrete positions on the flat sample, e.g. along one or more measurement tracks spaced apart from one another. In particular, the sensor module does not comprise an image sensor, or the sensor module is not designed to capture an image of the flat sample.

In particular, the sensor module or the device is designed to direct the illumination/excitation light (of the light source) in the form of converging or focused light beams (through the window) onto the flat sample, wherein at least some of the converging light beams of the illumination/excitation light run at an angle of at least 10° to one another. For example, the outer light beams of the illumination/excitation light converge at an angle of at least 10°, e.g. in a conical pattern. In particular, the illumination/excitation light is not directed onto the window and onto the flat sample under a parallel beam path.

For example, the device or the sensor module is designed to direct the illumination/excitation light (of the light source) onto the flat sample at an angle that deviates from the sample normal (direction perpendicular to the sample). The illumination/excitation light is then applied to the flat sample diagonally through the window, rather than in the direction of the sample normal.

The flat sample, or the detection region of the flat sample, captured during the recording of the measurement signal may be located at a measurement position which is separated from the target measurement plane by a measurement distance deviation when capturing the measurement signal. In particular, the device is designed to insert the flat sample into the target measurement plane, or into the region of the target measurement plane, in such a way that the flat sample or the detection region of the flat sample captured during the recording of the measurement signal can be located at a measurement position which is separated from the target measurement plane by a measurement distance deviation when capturing the measurement signal. The measurement position of the flat sample (or of the detection region of the flat sample captured during the recording of the measurement signal) can thus have an actual measurement distance from the sensor module which deviates from the module distance when capturing the measurement signal. The actual measurement distance a of the flat sample corresponds to the sum of the module distance d and a measurement distance deviation y: a=d+y. In particular, the device may be designed to insert the flat sample into the target measurement plane, or into the region of the target measurement plane, in such an inaccurate manner that the flat sample may be located slightly outside the target measurement plane (when capturing the measurement signal, at least intermittently or in sections). Inaccurate insertion is often unavoidable, e.g. if the flat sample is transported past the sensor module for testing.

For example, in the case of a moving flat sample, the flat sample is usually transported by means of a transport unit in such a way that the measurement position of the flat sample can deviate from the target measurement plane or the actual measurement distance can fluctuate when measuring the sample. The flat sample is transported past the sensor module in such a way that the flat sample (or the detection region of the flat sample captured when recording the measurement signal) may be located at a measurement position that is outside the target measurement plane/that is separated from the target measurement plane or that has a measurement distance deviation from the target measurement plane when capturing the measurement signal. The actual measurement distance can fluctuate, for example, due to a fluttering motion of the flat sample.

In particular, the measurement signal of the flat sample (which can be detected by taking the retroreflection effect into account) as a function of the measurement distance deviation y has a maximum value m and the module distance of the sensor module from the target measurement plane is selected to be sufficiently small that the maximum value m of the measurement signal is reached or would be reached at a maximum measurement position pm of the flat sample which is located outside the target measurement plane, in particular which lies behind the target measurement plane, i.e. on the side of the target measurement plane which faces away from the sensor module.

The measurement distance of the flat sample, at which the maximum value of the measurement signal (which can be detected by taking the retroreflection effect into account) would be reached, deviates from the module distance d, in particular by at least 0.2 mm. The maximum measurement position pm of the flat sample, at which the maximum value m of the measurement signal would be reached as a function of the measurement distance deviation, is preferably located at least 0.2 mm further away from the sensor module than the target measurement plane. In other words, the measurement distance of the flat sample at which the maximum value of the measurement signal (which can be detected by taking the retroreflection effect into account) would be reached, is greater than the module distance d, in particular by at least 0.2 mm.

In addition or alternatively, the module distance of the sensor module from the target measurement plane is selected to be sufficiently small that the maximum value of the measurement signal of the flat sample, which can be detected without taking the retroreflection effect into account, would also be reached at a measurement position of the flat sample located outside the target measurement plane, in particular behind the target measurement plane, i.e. located on the side of the target measurement plane facing away from the sensor module, wherein this measurement position is preferably at least 0.3 mm further away from the sensor module than the target measurement plane.

The measurement signal of the flat sample as a function of the measurement distance deviation y from the target measurement plane is subject to signal variation. In order to reduce or keep this to a minimum, the module distance d of the sensor module from the target measurement plane is selected to be suitably small.

Preferably, the module distance of the sensor module from the target measurement plane is selected to be sufficiently small that the signal variation of the measurement signal as a function of the measurement distance deviation y in the region of the target measurement plane (viewed in the direction of the sample normal or perpendicular to the window) in the range of +/−1 mm around the target measurement plane E is reduced by at least 50% (due to the retroreflection effect of the window) in comparison to a signal variation occurring without the retroreflection effect, or in comparison to a signal variation of the measurement signal of the flat sample occurring without the retroreflection effect of the window, as a function of the measurement distance deviation in the region of the target measurement plane.

Alternatively or in addition, the module distance of the sensor module from the target measurement plane is selected to be sufficiently small that the measurement signal of the flat sample as a function of the measurement distance deviation, for measurement positions of the flat sample having a measurement distance deviation (viewed in the direction of the sensor normal/perpendicular to the window) in a range of +/−1.0 mm around the target measurement plane (caused by the retroreflection effect of the window), has a maximum signal variation of 10% with respect to the measurement signal in the target measurement plane. In other words, the module distance of the sensor module from the target measurement plane is preferably selected to be sufficiently small that the signal variation of the measurement signal of the flat sample which can be obtained if the measurement position of the flat sample deviates from the target measurement plane by up to 1.0 mm in both directions (y=+/−1.0 mm) is no more than 10% with respect to the measurement signal in the target measurement plane.

Alternatively or in addition, the module distance of the sensor module from the target measurement plane is selected to be sufficiently small that the measurement signal of the flat sample as a function of the measurement distance deviation, for measurement positions of the flat sample over the entire section between the window and the target measurement plane (caused by the retroreflection effect of the window), has a maximum signal variation of 10% with respect to the measurement signal in the target measurement plane.

In some exemplary embodiments, the transport path of the flat sample in the device—at least in the region of the measurement position of the flat sample—(in the direction of the sample normal/perpendicular to the window) is mechanically bounded on both sides, and the transport path has a transport path width B (in the direction of the sample normal/perpendicular to the window) within which the measurement position of the flat sample may vary. The target measurement plane is located inside, e.g. in the center, of the transport path.

In order to reduce or keep the signal variation of the measurement signal as a function of the measurement distance deviation to a minimum, the module distance of the sensor module from the target measurement plane is then preferably selected to be sufficiently small that the measurement signal of the flat sample as a function of the measurement distance deviation over the entire transport path width (due to the retroreflection effect of the window) has a signal variation of a maximum of 15%, preferably a maximum of 10%, with respect to the measurement signal in the target measurement plane. For example, the transport path of the flat sample is bounded by the window on the side facing the sensor module and bounded by a mechanical boundary or by another window on the side facing away from the sensor module. The transport path width is then obtained (viewed in the direction of the sample normal/perpendicular to the window) from the distance between the window and the mechanical boundary or the other window.

Normally, the sensor module—in the case in which it is installed in the device—is assigned a target module distance d0 from the target measurement plane at which the sensor module—taking into account the optical beam path of the illumination/excitation light from the sensor module through the window to the flat sample and on the basis of the optical beam path of the optical radiation coming from the flat sample through the window to reach the sensor module, in particular of the remission or luminescence light—without taking account of the retroreflection effect of the window, would provide a maximum measurement signal of the flat sample, i.e. the measurement signal as a function of the measurement distance deviation would return a maximum. However, in order to reduce the signal variation of the measurement signal as a function of the measurement distance deviation, or keep it to a minimum, the module distance d of the sensor module from the target measurement plane is selected to be less than the target module distance d0 by at least 0.3 mm.

In some exemplary embodiments, the device has an additional window behind the target measurement plane, i.e. on the side of the target measurement plane facing away from the window, from which illumination/excitation light transmitted through the flat sample can be reflected back onto the flat sample. The additional window is located at a further window distance away from the target measurement plane and the further window distance is selected to be sufficiently small that the measurement signal of the flat sample is increased by an additional retroreflection effect of the additional window, in particular by at least 2% compared to a measurement signal that occurs or is able to be captured without the additional retroreflection effect of the additional window.

For example, the illumination/excitation light transmitted through the planar sample can undergo a retroreflection at the additional window and so be directed onto the planar sample once again and cause the same to emit optical radiation, in particular remission or luminescence light. Alternatively or in addition, optical radiation emitted in response to the illumination/excitation light, in particular remission or luminescence light, of the flat sample, which is emitted in the direction of the additional window, can be reflected back towards the flat sample at the additional window, transmitted through this and the window and reach the sensor module, to be detected by the sensor module and contribute to the measurement signal of the sensor module.

The sensor module can comprise an evaluation device which is designed to test the flat sample using one or more captured measurement signals of the flat sample, e.g. of an optical security feature of the flat sample, in particular to test its authenticity or quality.

The above-mentioned device can be a value document processing device, which is designed for testing flat samples in the form of value documents by means of the optical sensor module, in particular for testing the authenticity or the quality of the tested value documents, e.g. for testing an optical security feature of the respective value document. The device can also be designed to sort the tested value documents.

Alternatively, the above-mentioned device can be a device which is designed for producing value documents or producing semi-finished products used in the production of value documents, in or by means of which device the value documents or semi-finished products can be tested using the optical sensor module, for example, a device for producing a substrate web for value document substrates or a device for producing value document sheets comprising multiple value documents or semi-finished products. For example, it is a device for producing a paper web from which value document substrates can be produced, or a sheet printing device for producing value document sheets, which comprise multiple value documents or semi-finished products. The device is designed for testing, in particular quality testing, the value documents or the semi-finished products by means of the optical sensor module, e.g. for testing an optical security feature that the tested value documents or semi-finished products have or that the tested value documents or semi-finished products have been provided with in the production device. The optical security feature can be inserted into or attached to the value documents or semi-finished products.

The measurement signal of the flat sample can be output from the sensor module or the device, e.g. displayed to an external location or for an operator and/or appropriate information about the result of the test (e.g. value document or semi-finished product “OK” or “NOT OK”) can be output from the device or the sensor module, e.g. to an external location or for an operator.

The invention also relates to a method for testing the flat sample by means of the optical sensor module, which is designed for optically testing the flat sample. The method can be carried out by one of the devices described above or another device that comprises the sensor module and provides the target measurement plane.

In the method, the sensor module for optically testing the flat sample captures a measurement signal of the flat sample, corresponding to the intensity of an optical radiation, in particular of remission or luminescence light, of the flat sample when this is located in the target measurement plane or at least approximately in (e.g. at a distance of not more than +/−1 mm from) the target measurement plane outside the sensor module, in particular while the flat sample is transported along a transport path (located in or at least approximately in the target measurement plane) past the sensor module. The measurement signal is used to test the flat sample. The sensor module is located at a module distance away from the transport path or from the target measurement plane. Between the sensor module and the flat sample, a window is arranged, through which both illumination/excitation light irradiated onto the flat sample as well as the optical radiation reaching the sensor module from the flat sample, in particular remission or luminescence light (which is emitted from the flat sample as a result of the illumination/excitation light), is transmitted. The flat sample (or the detection region of the flat sample, captured during the recording of the measurement signal) may be located at a measurement position which is separated from the target measurement plane by a measurement distance deviation when capturing the measurement signal.

In the method, the window is located at a window distance away from the target measurement plane and the window distance is selected to be sufficiently small that the measurement signal of the flat sample is increased, in particular by at least 10%, by the retroreflection effect of the window in comparison to a corresponding measurement signal of the flat sample located in the target measurement plane occurring without the retroreflection effect. In addition, the module distance of the sensor module from the target measurement plane is selected to be sufficiently small that a signal variation of the measurement signal of the flat sample as a function of the measurement distance deviation in the region of the target measurement plane is reduced by the retroreflection effect of the window in comparison to a signal variation of the measurement signal of the flat sample occurring without the retroreflection effect (as a function of the measurement distance deviation in the region of the target measurement plane), i.e. in comparison to the case in which the window—e.g. due to its greater distance from the flat sample—causes no or only a negligibly small retroreflection effect.

The flat sample is, for example, a value document or a semi-finished product used in the production of value documents, in particular a value document substrate which can be used for producing a value document, or a value document sheet comprising multiple value documents, or a substrate web for value document substrates, e.g. a paper web, which can be used for producing value document substrates.

Preferably, the captured measurement signal is characteristic of at least one of the following optical properties of the flat sample, in particular of the semi-finished product or value document: remission, luminescence (fluorescence, phosphorescence), Raman scattering, in particular surface-enhanced Raman scattering (SERS), absorption or transmission.

When testing the flat sample, the measurement signal is used as a basis for testing, for example, an optical security feature of the flat sample or the value document or semi-finished product, in particular its presence and/or its type and/or quantity.

Preferably, the sensor module, in particular the evaluation device thereof, is designed to use the measurement signal to determine at least one characteristic property of the security feature inserted into or attached to the value document or semi-finished product and to test whether the determined characteristic property of the security feature corresponds to or is at least similar to at least one predetermined property. This means that it can be reliably concluded that a specific or desired security feature is present in the semi-finished product or the value document.

For example, the sensor module, in particular its evaluation device, tests whether the measurement signal corresponding to the intensity of the optical radiation is greater than a specified threshold value and/or is within a specified acceptance range. This makes it a simple matter to conclude that a certain or desired quantity of a/the desired security feature is present in/on the semi-finished product or value document.

The tested characteristic property of the security feature or the specified property is, for example, at least one of the following properties of the optical radiation emitted by the security feature of the semi-finished product or the value document: i) spectral properties, such as the intensity in certain spectral regions (fingerprint), the position, intensity or width of spectral maxima, minima or shoulders, in absolute terms or relative to each other; ii) temporal properties, such as the intensity at certain points in time relative to an excitation pulse of the irradiation, in absolute terms or relative to each other, a decay or settling time, a curve or a functional form (fitting parameter) of the time-resolved intensity, the location or intensity of a temporal intensity maximum; iii) combinations of spectral and temporal properties (e.g. decay times in multiple spectral channels, emission spectrum at multiple measurement times); iv) properties after complex excitation by the irradiation (e.g. multiple excitation wavelengths, complex temporal modulation of the excitation light).

Preferably, the security feature is invisible to the naked eye in ambient light. Preferably, a security feature is used for which the optical radiation (remission, luminescence) emitted from the security feature during the test in response to the illumination/excitation light is located in the invisible spectral range. The invisible spectral range includes, for example, the infrared and ultra-violet spectral range, preferably between 100 nm and 380 nm and between 780 nm and 100 μm, in particular between 780 nm and 3 μm. The illumination/excitation light can be in the visible or invisible spectral range.

Further advantages, features and possible applications of the present invention can be found in the following description in connection with the drawings, in which:

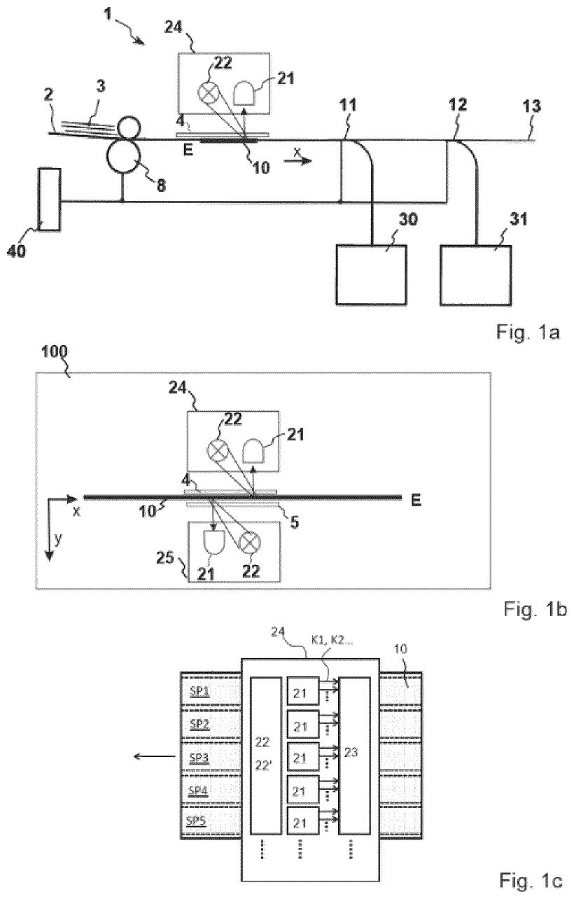

FIG. 1a-c shows schematic representations of a value document processing device (FIG. 1a), a detail of a production device for value document substrates or for value documents (FIG. 1b), and a sensor module designed for a multi-track test (FIG. 1c),

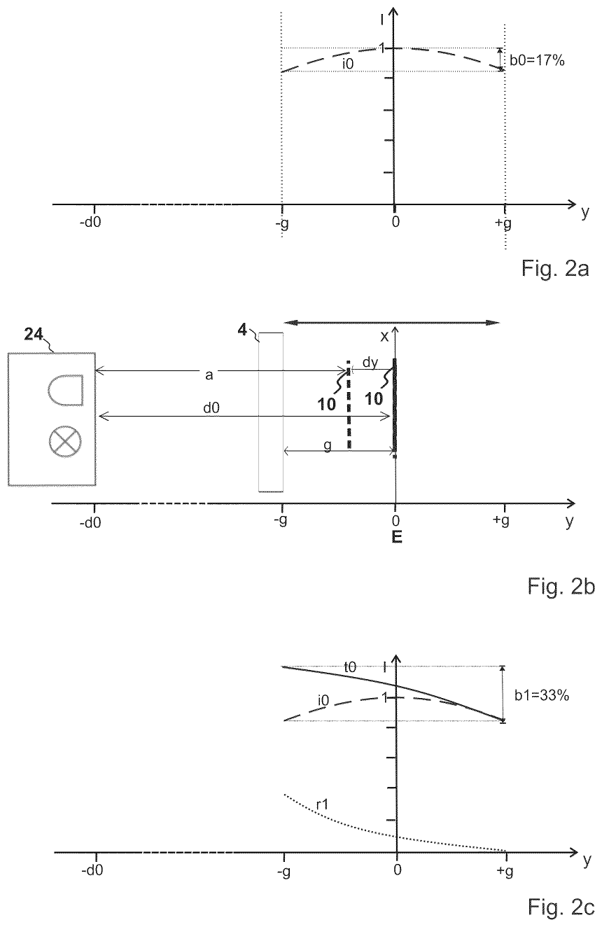

FIG. 2a shows an example of the trace of the measurement signal of the flat sample as a function of the measurement distance deviation y from the target measurement plane E in a sensor module without a retroreflection effect arranged at the target module distance d0 from the target measurement plane,

FIG. 2b shows a schematic representation of the previous arrangement of the sensor module at the target module distance d0 from the target measurement plane E of the flat sample,

FIG. 2c shows an example of the trace of the measurement signal of the flat sample as a function of the measurement distance deviation y from the target measurement plane E in a sensor module with retroreflection effect arranged at the target module distance d0,

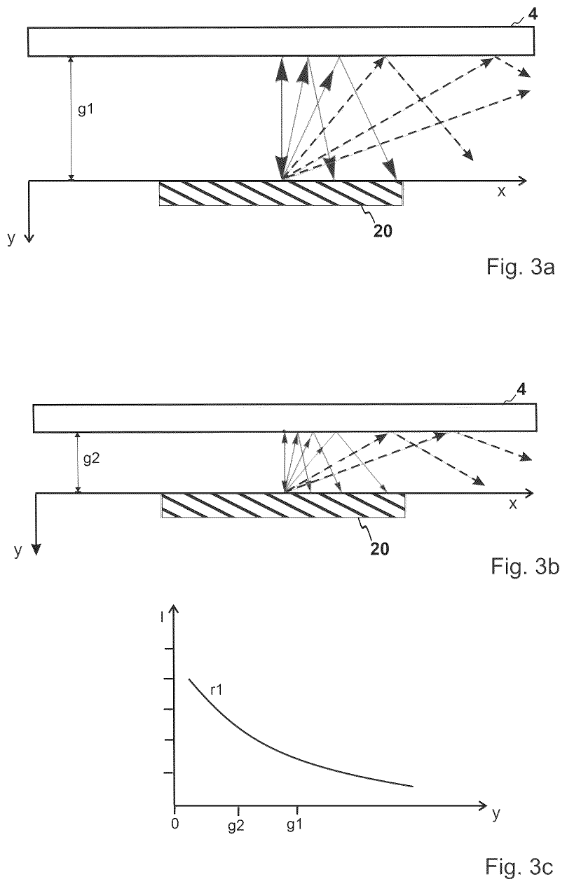

FIG. 3a-c shows an exemplary path of light beams with the retroreflection effect for different window distances g1 (FIGS. 3a) and g2 (FIG. 3b) and the increase of the measurement signal due to the retroreflection effect (FIG. 3c),

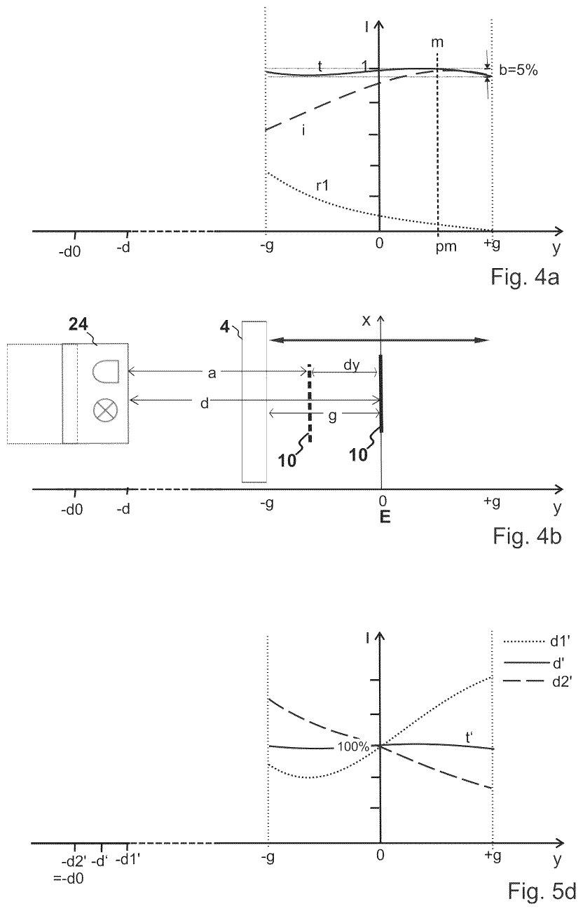

FIG. 4a shows an example of the trace of the measurement signal of the flat sample as a function of the measurement distance deviation y from the target measurement plane E in a sensor module arranged according to the invention at the distance d with retroreflection effect,

FIG. 4b shows an example of an arrangement according to the invention of the sensor module at a smaller distance d from the target measurement plane E of the flat sample in the case of only one window,

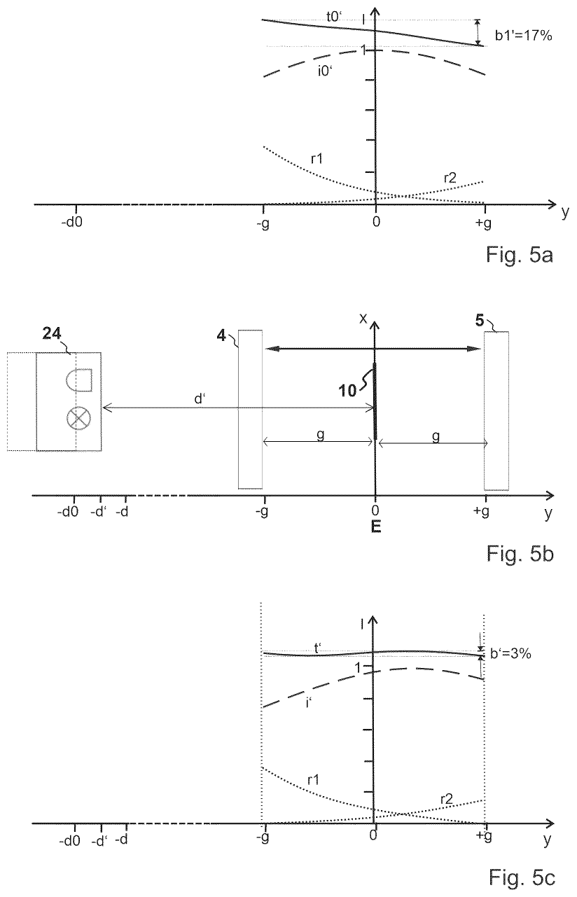

FIG. 5a shows the increase in the measurement signal due to the retroreflection effect with additional retroreflection effect due to the additional window,

FIG. 5b shows a schematic representation of the arrangement according to the invention of the sensor module at a smaller distance d′ from the target measurement plane E in the case of an additional window,

FIG. 5c shows an example of the trace of the measurement signal of the flat sample as a function of the measurement distance deviation y from the target measurement plane E in a sensor module arranged according to the invention at the distance d′ with retroreflection effect of both windows,

FIG. 5d shows a trace of the measurement signal of the flat sample as a function of the measurement distance deviation y from the target measurement plane E with retroreflection effect of both windows for different module distances of the sensor module.

FIG. 1a shows a schematic representation of a value document processing device 1 for value documents, which is designed for testing individual value documents 10, e.g. testing the authenticity or the quality of value documents. In this case, the value documents 10 are provided in an input tray 2 of the value document processing device 1 in the form of a value document stack 3. From the input tray, the value documents 10 are withdrawn individually one after another by means of a separating unit 8 and transported by means of a transport unit, for example rollers and/or belts, along a transport direction x past a sensor module 24, which is designed to perform an optical authenticity or quality test of an optical security feature of the value documents. Depending on whether or not the respective value document meets the criteria applied during the visual inspection, the respective value document can be transported to a first output tray 30 or to a second output tray 31. A control device 40 of the device controls the diverters 11, 12 of the device accordingly to sort the value documents. Alternatively, the value documents 10 can also be transported via the transport section 13 to other devices of the value document processing device 1.

FIG. 1b shows a schematic representation of a production device 100 which can be used in the production of value documents, which is designed for producing a paper web 10 for value document substrates. The sensor module 24 is designed to perform optical quality testing of the paper web 10 with regard to an optical security feature. Depending on whether or not the particular section of the paper web tested meets the criteria applied during the optical test, a corresponding quality classification can be assigned to the respective section of the paper web so that the respective section of the paper web that does not meet the criteria can be discarded. Optionally, the relevant section of the paper web that does not meet the criteria can be marked for this purpose.

The production device 100 can also be a sheet-fed printing device for producing value document sheets 10, which contain a plurality of value documents or semi-finished products arranged in a matrix. The sheet-fed printing device is, for example, a printing machine for value document sheets, in which an optical security feature is printed on the value documents to be produced from the respective value document sheet by means of a printing device. The sensor module 24 is arranged in the printing machine after the printing device in order to carry out a print inspection of the security feature printed on the sheet. In the sheet-fed printing device, the value document sheets 10—similarly to the value documents in FIG. 1a—can be separated from the stack, transported and tested. A quality classification can be assigned to each printed sheet 10 so that the particular printed sheet that does not meet the criteria can be discarded. Optionally, the relevant printed sheet that does not meet the criteria can be marked for this purpose.

In the example of FIG. 1a, a sensor module 24 is shown, but a second sensor module 25 may also be arranged on the opposite side of the transport path as shown in FIG. 1b. Furthermore, the device 1 may also contain further sensor modules for further tests of the value documents, e.g. an image sensor or a magnetic sensor.

In the example of FIG. 1b, in place of the two oppositely placed sensor modules 24, 25, it is also possible to use only one of the sensor modules 24 in the event that a single-sided inspection of the optical security feature is sufficient.

The flat sample 10 is transported past the sensor module 24 in the transport direction x in the respective device 1, 100 by means of a suitable transport unit. Ideally, the respective value document is located in a target measurement plane E during transport. The sensor module 24 is configured to detect optical radiation emanating from the flat sample while the flat sample is moved past the sensor module 24. The sensor module 24 has at least one light source 22, which is configured to irradiate the illumination or excitation light onto the flat sample, and at least one detector device 21, which is configured to detect the optical radiation emanating from the flat sample.

The optical radiation emitted by the flat sample in response to the illumination/excitation light irradiated onto the flat sample is, for example, remission light, luminescence light or Raman-scattered light.

At one or more instants, when the flat sample 10 is located in the target measurement plane E in the detection range of the sensor module 24, the sensor module captures one or more measurement signals of the flat sample 10, corresponding to the intensity of the optical radiation, e.g. of remission or luminescence light, of the flat sample. In the present example, it is assumed that the optical radiation is remission or luminescence light of the flat sample.

FIG. 1c shows a schematic plan view of the sensor module 24, under which a flat sample 10 to be tested is located, which can be a value document, a value document sheet or printed sheet, or a paper web, depending on the use of the sensor module 24. For illustrative reasons, a flat sample 10 in the form of a value document is shown schematically in the present example.

The sensor module 24 can be designed for a single-track or multi-track measurement of the flat sample in order to detect the measurement signals of the flat sample along one or more tracks SP1 to SP5. For this purpose, the sensor module 24 has a number of detector devices 21 corresponding to the number of tracks, wherein each of the detector devices 21 is assigned to one of the tracks SP1 to SP5. For example, the detector devices 21 are each configured to detect the optical radiation emitted from the flat sample in one or more spectral regions or spectral channels K1, K2, . . . and to forward the corresponding signals to a test device 23 in which they are further processed or tested. A first light source 22 and optionally an additional, second light source 22′ in the present example is configured to apply optical radiation to all tracks SP1 to SP5 on the flat sample simultaneously. Alternatively, however, it is also possible to provide a separate light source 22 and optionally 22′ for each of the tracks SP1 to SP5.

FIG. 2a shows a result of a simulation calculation of the hitherto standard optical beam path of the sensor module 24, which shows the expected curve of a measurement signal of the flat sample 10 located in the target measurement plane E, which signal can be detected through the window 4 by means of the sensor module 24, as a function of the measurement distance deviation y from the target measurement plane E (which is at y=0). This calculation takes account of the influence of the window 4 on the direct beam path, the shape (focus position, divergence, direction) of the illumination/excitation light and of the detection range, as well as their overlap, which are matched to one another in the sensor module. The simulation calculation results in a curve with a maximum of the expected measurement signal at a specific distance from the sensor module 24, which is referred to in the following as the target module distance d0. In order to detect the largest possible measurement signal of the sensor module 24, it has hitherto been standard practice to arrange the sensor module 24 at this target module distance d0 from the target measurement plane E (predetermined for the flat sample by the device 1, 100), at which the measurement signal of the flat sample, if it is located in its target measurement plane E, reaches its maximum, see FIG. 2a. In this simulation calculation, the reflection effect of the window 4, explained in more detail below, was disregarded, since its influence on the signal curve of the measurement signal was only detected prior to the present invention.

FIG. 2b shows the corresponding previous arrangement of the sensor module 24 at the target module distance d0 from the predetermined target measurement plane E of the flat sample 10. Between the sensor module and the target measurement plane E, the window 4 is located at the position corresponding to the measurement distance deviation y=−g, where g is, for example, in the range of 0.3 mm to 3 mm. In the case of a flat sample 10 which is transported perpendicular to the y direction, the window 4 bounds, for example, the transport path of the flat sample 10.

However, when the flat sample is introduced into the target measurement plane E, as for example when transporting the flat sample past the sensor module by means of a transport unit, it can happen that the flat sample is positioned slightly outside the desired target measurement plane E, e.g. due to fluttering movements, so that distance fluctuations in relation to the sensor module 24 may occur. For this purpose, as an example in FIG. 2b, the position of a flat sample 10 is shown (dashed), which is spaced apart by a measurement distance deviation y=dy from the target measurement plane E and accordingly has an actual measurement distance a from the sensor module which differs from the target module distance d0. If the actual measurement distance a of the flat sample differs from the target module distance d0, i.e. the sample is located outside of the target measurement plane E, then previously—even without a retroreflection effect—a marked signal variation of the measurement signal would occur, e.g. by b0=17% in the range +g to −g around the target measurement plane E, see FIG. 2a.

Prior to the invention, it was recognized that in a sensor module with an upstream window which is very close to the target measurement plane, two effects can contribute to the observed signal variation of the measurement signal depending on the exact position of the flat sample:

Firstly, the sensor module itself has an intrinsic distance dependence i0, see FIG. 2a. This is usually of such a form that the measurement signal as a function of the sample distance has a local maximum, namely at its target module distance, at which a maximum measurement signal is detected from a sample.

Secondly, with a very small window distance from the window 4 to the target measurement plane, an increase in the measurement signal is obtained due to a retroreflection effect of the window 4 for flat samples, which are then located very close to the window. For example, the window is a coated or uncoated glass plate. To explain this retroreflection effect, FIGS. 3a and 3b show examples of the path of light beams subject to the retroreflection effect for different distances g1=1 mm (FIGS. 3a) and g2=0.5 mm (FIG. 3b) of the window 4 from the flat sample 10. The detection region 20 of the flat sample 10 extends in the direction x perpendicular to the optical axis or on the sample surface from −1 mm to +1 mm.

The light beams shown in solid lines in FIGS. 3a and 3b emanate from the sample surface in the center of the detection region 20, are reflected at the window 4 and reenter the detection region 20 of the flat sample 10 and can contribute to the measurement signal. The dashed light beams on the other hand are incident outside the detection region 20 and do not contribute to the signal. As is evident, in the case of a small distance between sample and window (see FIG. 3b), reflections from a larger angular range contribute to the measurement than in the case of a larger distance (see FIG. 3a).

For a remission measurement, this retroreflection effect arises in the following manner: the illumination light passes through the window onto the flat sample. At the sample surface, the illumination light is scattered in all directions and strikes the window again at different angles. At large angles (approx. >50°) in accordance with the reflection law, a significant proportion of the illumination light at the window 4 is reflected back in the direction of the flat sample 10 at the junction between an optically thinner medium (air) and an optically denser medium (window). This illumination light can then be scattered at the sample surface in the direction of the sensor module 24. If the distance from flat sample to window is small, the offset when the light strikes the sample again remains small, even for very large angles. If the offset is still within the detection range 20, the illumination light reflected back at the window 4 and scattered once again at the sample also contributes to the measurement signal of the sensor module 24.

For a luminescence measurement, two effects occur at the window 4:
firstly, excitation light is scattered at the flat sample, reflected back to the flat sample at the window 4 as described above, and can excite luminescence again there. Secondly, luminescence excited in the flat sample is radiated isotropically in all directions and strikes the window 4 at different angles. At large angles (approx. >50°), a significant proportion of the light is reflected at the window 4, again in the direction of the flat sample. This light can then be scattered at the sample surface again in the direction of the sensor module 24. Both effects contribute to the measured luminescence measurement signal only if the light strikes the sample within the detection range 20 after reflection at the window 4. For a small distance g1 between flat sample and window, this is the case for a larger angular range than for a larger distance g1, which increases the measured luminescence measurement signal.

In FIG. 3c, the increase in the measurement signal caused by the retroreflection effect is sketched for small measurement distances, cf. curve r1. An analogous retroreflection effect can also occur at an additional window 5 arranged at the rear boundary of the measurement range or transport path, see FIG. 1b and FIG. 5a-d, and contribute to a further increase in the measurement signal.

In FIG. 2c, the trace of the measurement signal of the flat sample is shown as a function of the measurement distance deviation y from the target measurement plane E in a sensor module 24 with retroreflection effect arranged at the target module distance d0. Here, the curve designated by i0 is the intrinsic distance dependence of the sensor module 24 if it is positioned at the target module distance d0 from the target measurement plane E, see FIG. 2a. The curve designated by r1 shows the increase in the measurement signal due to the retroreflection effect from FIG. 3c and the curve designated by to shows their superposition or sum of the curves i0 and r1. The resulting curve t0 shows that, taking into account the retroreflection effect, an even greater signal variation of the measurement signal occurs with the hitherto standard target module distance d0 than without the retroreflection effect (cf. b0=17% in FIG. 2a), e.g. by b1=33% in the region +g to −g around the target measurement plane E.

Positioning the sensor module at the target module distance d0 corresponds to the hitherto standard procedure, since it is obtained—regardless of the strength or the presence of the retroreflection effect—even with purely empirical optimization of the measured or measurable level of the measurement signal. To this end, a stationary flat sample has hitherto been positioned exactly in the target measurement plane E of the sensor module. Thereafter, the module spacing has then been varied such that—under otherwise identical conditions—the measurement signal of the flat sample is maximized. The module distance set in this way corresponds precisely to the target module distance d0 of the sensor module.

It was discovered that the intrinsic distance dependence i0 of the sensor module 24 and the signal increase due to the retroreflection effect r1, r2 of the window/s 4, 5 can at least partially compensate each other when the sensor module 24 is positioned at a different distance from the target measurement plane E. To do so, the sensor module 24 is preferably positioned at a module distance d which is closer to the target measurement plane E than the hitherto standard target module distance d0, which is predetermined by the intrinsic distance dependence i0 and its maximum, see FIG. 4a, 4b.

In the exemplary embodiment of FIG. 4a, 4b, only one window 4 between the sensor module 24 and the target measurement plane E is used, but no rear-facing window 5. Optionally, however, there can still be a rear boundary of the transport path, which is, for example, opaque and has either no or only negligibly low retroreflection. In this exemplary embodiment, the sensor module 24 is positioned at a module distance d=4.9 mm, which is closer to the target measurement plane E than the target module distance d0=5.7 mm specified for the sensor module, see FIG. 4b.

The curve designated by i in FIG. 4a shows the intrinsic distance dependence i of the sensor module 24 when it is positioned at the module distance d from the target measurement plane E. In comparison to the intrinsic distance dependence i0 for a positioning at the target module distance d0 as in FIG. 2a, 2c, this intrinsic distance dependence i is shifted to the right. The curve designated by r1 in FIG. 4a shows the increase in the measurement signal due to the retroreflection effect, and the curve designated by t shows their superposition or sum of the curves i and r1. The resulting curve t shows that the decrease of the measurement signal due to the module distance deviating from the target module distance d0 compensates for the intensity increase due to the retroreflection at the window 4 quite well.

Since the module distance d from the target measurement plane E is selected to be less than the standard target module distance d0, however, the maximum measurement position pm at which the maximum measurement signal m would be reached is now located behind the target measurement plane E, i.e. on the side of the target measurement plane E facing away from the sensor module 24, see FIG. 4a. In this exemplary embodiment, this maximum measurement position is at pm=+0.7 mm. However, the measurement signal of a flat sample located in the target measurement plane E is only slightly reduced compared to the maximum measurement signal and is still sufficiently high in terms of its signal-to-noise ratio.

Due to the selectively modified module distance d in conjunction with the retroreflection effect of the window, the signal variation of the measurement signal as a function of the measurement distance deviation y in the region of the target measurement plane E is significantly reduced. In this exemplary embodiment, the signal variation of the measurement signal as a function of the measurement distance deviation y is only b=5% over the entire width of the transport path (from −g to +g). In comparison, the curve i in FIG. 4a and the curve i0 shown in FIG. 2a with the signal variation b0=17% shows that without the interaction between the modified module distance d and the retroreflection effect of the window, a significantly larger signal variation of the measurement signal would occur.

This signal variation of b=5% is significantly lower than for other module distances and in comparison to the same sensor module without windows or without the retroreflection effect of a window. The small signal variation makes it possible, for example in an authenticity test, to select a much narrower acceptance range for items judged to be genuine, which makes the authenticity test stricter and more reliable.

The reduction of the signal variation achieved according to the invention by optimization of the sensor distance can be used in all known luminescence and remission sensors with a limited illumination and/or detection range. In particular, the illumination and detection beam paths can be arranged parallel to or at an angle to each other, and any kind of optical arrangements for concentrating the illumination or detection onto a limited region can be used, in particular collimated and focused beams with lenses, concave mirrors and other optical components in the beam path. The method is applicable to any illumination and detection wavelengths.

In a second exemplary embodiment, the rear-side boundary of the transport path is formed by a further window 5 at a distance g from the target measurement plane E, which also causes a retroreflection of the illumination or excitation light, see FIG. 5b. However, the window 5 can also be arranged at a different distance from the target measurement plane E than the window 4.

Even in the case of two windows 4, 5, using the standard optimization of the level of the measurement signal on a stationary sample it has hitherto been possible to achieve a position of the sensor module at the target module distance d0, as described above. With the standard method of positioning the sensor module 24 at the target module distance d0, the curves i0′ shown in FIG. 5a are then obtained for the intrinsic distance dependence of the sensor module 24, curves r1 and r2 for the increase in the measurement signal due to the retroreflection effect at the two windows 4 and 5, and the curve t0′ for their superposition or sum of the curves i0′, r1 and r2. The signal variation of the curve t0′ over the whole region between the windows is then b1′=17%, see FIG. 5a.

The additional retroreflection effect of the rear-side window 5 results in a different preferred module distance d′ for the sensor module 24, at which the decrease of the measurement signal due to the measurement distance deviating from the target measurement plane compensates well for the rise in intensity due to the retroreflections at the windows 4 and 5. In order to keep the resulting signal variation of the measurement signal as small as possible, the sensor module is positioned in this exemplary embodiment at a module distance d′=5.2 mm, which lies between the target module distance d0=5.7 mm and the module distance of d=4.9 mm selected in the exemplary embodiment with only one window 4 (see FIG. 4a, b), see FIG. 5b.

FIG. 5c shows the trace of the measurement signal of the flat sample 10 as a function of the measurement distance deviation y from the target measurement plane E for the sensor module arranged at a module distance of d′=5.2 mm with a retroreflection effect of both windows 4, 5. In the case of two windows 4, 5, the maximum of the intrinsic distance dependence i′ is positioned closer to the target measurement plane E than in the case of only one window 4. For the module distance of d′=5.2 mm, the remaining signal variation of the curve t′ resulting from i′, r1 and r2 over the whole region between the windows is only approximately b′=3%, see FIG. 5c.

FIG. 5d shows how in the case of the two windows 4, 5 the dependence of the measurement signal on the measurement distance deviation y and the signal variation of the measurement signal changes over the region between the windows when the distance of the sensor module 24 from the optimized module distance d′=5.2 mm is varied by 0.5 mm forwards or backwards to d1′=4.7 mm and d2′=d0=5.7 mm. Each curve has been normalized individually to the measurement signal in the target measurement plane E (100%). Both at a module distance of d1′=4.7 mm and at a module distance of d2′=d0=5.7 mm, a large signal variation of the measurement signal of over 20% is obtained, which is significantly higher than in the case of the module distance d′=5.2 mm optimized for both windows 4, 5 (only approx. 3%).

The sensor module 24 may optionally also have multiple measurement tracks, cf. FIG. 1c, and a number of detector devices 21 corresponding to the number of tracks. If the distances of the detector devices 21 can be individually adjusted, for each of the detector devices 21 a measurement distance optimized with regard to the signal variation of the measurement signal can be selected, as described above. Due to manufacturing tolerances of the detector devices, a sensor module can thus be produced in which each detector device 21 has an individually distinct distance to the target measurement plane E. For example, the detector devices of a sensor module 24 have individual relative positions which deviate from those of other sensor modules of the same series. If, however, the distances of the detector devices 21 from the target measurement plane E cannot be individually set in the sensor module 24, the module distance of the (entire) sensor module 24 can be set in such a way that it is optimized with regard to the signal variation of the measurement signal for a specific measurement track, e.g. the most important measurement track with regard to the testing of the flat sample. Alternatively, the module distance of the sensor module 24 with regard to the signal variation of the measurement signal can also be optimized on the basis of an (optionally weighted) mean value of the measurement signals of multiple or all measurement tracks of the sensor module 24.

1.-15. (canceled)

16. A device for testing a flat sample, wherein the device
provides a target measurement plane for the flat sample, into which the flat sample can be introduced for testing, and
has an optical sensor module for optically testing the flat sample, said module being designed to capture a measurement signal of the flat sample corresponding to the intensity of an optical radiation, including remission or luminescence light, of the flat sample when the sample is located in the target measurement plane or at least approximately in the target measurement plane, while the flat sample is transported along a transport path past the sensor module, and
wherein the sensor module is located at a module distance away from the target measurement plane, and between the sensor module and the flat sample a window is arranged, through which both illumination/excitation light irradiated onto the flat sample and the optical radiation from the flat sample reaching the sensor module, including remission or luminescence light, is transmitted,
wherein while the measurement signal is being captured the flat sample can be located at a measurement position which is separated from the target measurement plane by a measurement distance deviation,
wherein the window is located at a window distance away from the target measurement plane and the window distance is selected to be sufficiently small that the measurement signal of the flat sample in the target measurement plane is increased by a retroreflection effect of the window in comparison to a corresponding measurement signal of the flat sample located in the target measurement plane occurring without the retroreflection effect, and
that the module distance of the sensor module from the target measurement plane is selected to be sufficiently small that a signal variation of the measurement signal of the flat sample as a function of the measurement distance deviation in the region of the target measurement plane is reduced by the retroreflection effect of the window compared to a signal variation of the measurement signal of the flat sample occurring without the retroreflection effect.

17. The device as claimed in claim 16, wherein the module distance of the sensor module from the target measurement plane is selected to be sufficiently small for the signal variation of the measurement signal as a function of the measurement distance deviation, in the region of the target measurement plane in the range of +/−1 mm around the target measurement plane, to be reduced by the retroreflection effect of the window, by at least 50% compared to a signal variation occurring without the retroreflection effect.

18. The device as claimed in claim 16, wherein the sensor module and the window are arranged and designed in such a way that the following contribute to the retroreflection effect of the window,
that a portion of the illumination/excitation light is reflected or scattered at the flat sample toward the window and then reflected back from the window to the flat sample and causes the flat sample to emit additional optical radiation, including additional remission or luminescence light, which is reflected or scattered in the direction of the window in such a way that it can be detected by the sensor module through the window and contributes to the measurement signal, and/or
that the optical radiation emitted by the flat sample, including remission or luminescence light caused by the illumination/excitation light, strikes the window and a component of the optical radiation, including the remission or luminescence light, is reflected back to the flat sample again at the window and then reflected or scattered again at the flat sample in the direction of the window in such a way that it can be detected by the sensor module through the window and contributes to the measurement signal.

19. The device as claimed in claim 16, wherein the measurement signal of the flat sample as a function of the measurement distance deviation has a maximum value and wherein the module distance of the sensor module from the target measurement plane is selected to be sufficiently small that the maximum value of the measurement signal would be reached at a maximum measurement position of the flat sample which is located outside the target measurement plane, and which lies on the side of the target measurement plane which faces away from the sensor module.

20. The device as claimed in claim 16, wherein the device or the sensor module is designed to direct the illumination/excitation light onto the flat sample in the form of converging light beams,
wherein at least some of the converging light beams of the illumination/excitation light run at an angle of at least 10° to one another.

21. The device as claimed in claim 16, wherein the device or the sensor module is designed to direct the illumination/excitation light onto the flat sample at an angle that deviates from the sample normal of the flat sample.

22. The device as claimed in claim 16, wherein the module distance of the sensor module from the target measurement plane is selected to be sufficiently small that the measurement signal of the flat sample as a function of the measurement distance deviation, for measurement positions of the flat sample having a measurement distance deviation lying in a range of +/−1.0 mm around the target measurement plane, has a maximum signal variation of 10% with respect to the measurement signal in the target measurement plane.

23. The device as claimed in claim 16, wherein the module distance of the sensor module from the target measurement plane is selected to be sufficiently small that the measurement signal of the flat sample as a function of the measurement distance deviation, for measurement positions of the flat sample over the entire section between the window and the target measurement plane, has a maximum signal variation of 10% with respect to the measurement signal in the target measurement plane.

24. The device as claimed in claim 16, wherein
in order to capture the measurement signal the flat sample is transported along a transport path past the sensor module and the transport path of the flat sample is mechanically bounded on both sides, at least in the region of the measurement position of the flat sample, and has a transport path width, and
the module distance of the sensor module from the target measurement plane is selected to be sufficiently small that the measurement signal of the flat sample as a function of the measurement distance deviation over the entire transport path width has a maximum signal variation of 15% with respect to the measurement signal in the target measurement plane.

25. The device as claimed in claim 16, wherein the sensor module is assigned a target module distance to the target measurement plane, at which the sensor module would deliver a maximum measurement signal of the flat sample without including the retroreflection effect of the window, and the module distance of the sensor module from the target measurement plane is selected to be at least 0.3 mm less than the target module distance.

26. The device as claimed in claim 16, wherein
the device has an additional window on the side of the target measurement plane which faces away from the window, from which illumination/excitation light transmitted through the flat sample can be reflected back onto the flat sample, and
the additional window is located at a further window distance away from the target measurement plane and the further window distance is selected to be sufficiently small that the measurement signal of the flat sample is increased by an additional retroreflection effect of the additional window, by at least 2% compared to a measurement signal occurring without the additional retroreflection effect of the additional window.

27. The device as claimed in claim 16, wherein the device is a value document processing device, which is designed for testing flat samples in the form of value documents by means of the optical sensor module, for testing the authenticity or the quality of the tested value documents.

28. The device as claimed in claim 16, wherein the device is designed for producing value documents or for producing semi-finished products used in the production of value documents, in which device the value documents or semi-finished products can be tested by means of the optical sensor module.

29. A method for testing a flat sample by means of an optical sensor module, which is designed for optically testing the flat sample,
wherein the method is carried out by a device as claimed in claim 16,
wherein for optically testing the flat sample the sensor module captures a measurement signal of the flat sample corresponding to the intensity of an optical radiation, including remission or luminescence light, of the flat sample when the sample is located in a target measurement plane specified for the flat sample, or at least approximately in the target measurement plane, while the flat sample is transported along a transport path past the sensor module,
wherein the sensor module is located at a module distance away from the target measurement plane, and between the sensor module and the flat sample a window is arranged, through which both illumination/excitation light irradiated onto the flat sample and the optical radiation from the flat sample reaching the sensor module, including remission or luminescence light, is transmitted,
wherein while the measurement signal is being captured the flat sample can be located at a measurement position which is separated from the target measurement plane by a measurement distance deviation,
wherein the window is located at a window distance away from the target measurement plane and the window distance is selected to be sufficiently small that the measurement signal of the flat sample is increased by a retroreflection effect of the window in comparison to a corresponding measurement signal of the flat sample located in the target measurement plane occurring without the retroreflection effect, and
that the module distance of the sensor module from the target measurement plane is selected to be sufficiently small that a signal variation of the measurement signal as a function of the measurement distance deviation in the region of the target measurement plane is reduced by the retroreflection effect of the window compared to a signal variation of the measurement signal of the flat sample occurring without the retroreflection effect.

30. The method as claimed in claim 29, wherein the flat sample
is a value document or
a semi-finished product used in the production of value documents, or a value document sheet comprising multiple value documents or semi-finished products, or a substrate web for value document substrates, which can be used for producing value document substrates.
